(19) United States
(12) Patent Application Publication
(10) Pub. No.: US 2012/0239452 A1
(43) Pub. Date: Sep. 20, 2012

(54) Fleet Management Systems and Processes

(76) Inventors: Aarjav Trivedi, (US); Arun Kumar Elangovan, (US); Ram Kumar Hariharan, (US)

(21) Appl. No.: 13/422,912

(22) Filed: Mar. 16, 2012

Related U.S. Application Data
(60) Provisional application No. 61/453,693, filed on Mar. 17, 2011.

(51) Int. Cl. G06Q 10/06

(52) U.S. Cl. 705/7.22; 705/7.12

(57) ABSTRACT

Automated fleet management systems and associated processes. In one embodiment, a method can be provided. The method can include receiving a service request from one or more customers, providing the one or more customers with a plurality of resources to select from, wherein the plurality of resources is ranked by a pain measure, and based at least in part on a customer selection of at least one resource with a pain measure, assigning at least one resource to the one or more customers.

### RELATED APPLICATION

This application claims priority to U.S. Ser. No. 61/453,693, titled “Fully Automated, Cloud Based, Fleet Management System with Automated Requests, Automated Dispatch, Automated Notifications, Tracking and Real Time People and Vehicle Analytics,” filed on Mar. 17, 2011, the contents of which are incorporated herein by reference.

### FIELD OF THE INVENTION

This invention generally relates to fleet management systems, and more particularly to, fleet management systems and processes.

### SUMMARY OF THE INVENTION

According to example embodiments of the invention, fleet management systems and processes are provided. In certain embodiments, systems and methods can be provided for fully automated, cloud based fleet management which can accept service requests from customers without any human intervention.

In one embodiment, a method can be provided. The method can include receiving a service request from one or more customers; providing the one or more customers with a plurality of resources to select from, wherein the plurality of resources is ranked by a pain measure; and based at least in part on a customer selection of at least one resource with a pain measure, assigning at least one resource to the one or more customers.

In one embodiment, a system can be provided. The system can include a processor operable to execute computer-executable instructions stored in at least one memory. The at least one memory can be operable to store a dispatch module with computer-executable instructions operable to receive a service request from one or more customers; provide the one or more customers with a plurality of resources to select from, wherein the plurality of resources is ranked by a pain measure; and based at least in part on a customer selection of at least one resource with a pain measure, assign at least one resource to the one or more customers.

In another embodiment, one or more computer-readable media can be provided. The one or more computer-readable media can store computer-executable instructions that, when executed by at least one processor, configure the at least one processor to receive a service request from one or more customers; provide the one or more customers with a plurality of resources to select from, wherein the plurality of resources is ranked by a pain measure; and based at least in part on a customer selection of at least one resource with a pain measure, assign at least one resource to the one or more customers.

In yet another embodiment, a method can be provided. The method can include receiving a plurality of service requests from a respective plurality of customers, receiving location data associated with a plurality of resources, receiving price data associated with the plurality of resources, providing at least one of the customers with a selectable list of resources and associated price data, and after customer selection of at least one resource, notifying the selected resource of the respective service request from the customer.

Other embodiments and aspects of the invention are described in detail herein and are considered a part of the inventions. Other embodiments and aspects can be understood with reference to the following figures and detailed description.

### BRIEF DESCRIPTION OF THE FIGURES

FIG. 1 depicts an example fleet management system according to an embodiment of the invention.

FIG. 2 illustrates example application program modules for the system shown in FIG. 1.

FIG. 3 illustrates a flowchart for an example method according to an embodiment of the invention.

FIG. 4 illustrates a flowchart for another example method according to an embodiment of the invention.

FIGS. 5-12 illustrate example screenshots for an example fleet management system and example method according to an embodiment of the invention.

### DETAILED DESCRIPTION

According to example embodiments of the invention, fleet management systems and processes are provided. In certain embodiments, systems and methods can be provided for fully automated, cloud based fleet management which can accept service requests from customers without any human intervention. In other embodiments, a service marketplace can be provided.

In one embodiment, multiple service requests from multiple customers can be matched to available resources, such as customers trying to travel to different locations by taxi, bus, and other public and/or private transit. Each of the customers operating a client device, such as a mobile phone, can be provided with a selectable list of resources to select from. Each of the resources can be ranked by a pain measure, which identifies a combination of cost, time, and one or more customer preferences. Each of the customers can select, via the mobile phone, a resource, based on the pain measure, and the selected respective resource can be assigned to each of the customers.

Embodiments of the invention will be described more fully hereinafter. This invention may, however, be embodied in many different forms and should not be construed as limited to the embodiments set forth herein; rather, these embodiments are provided so that this disclosure will be thorough and complete, and will fully convey the scope of the invention to those skilled in the art.

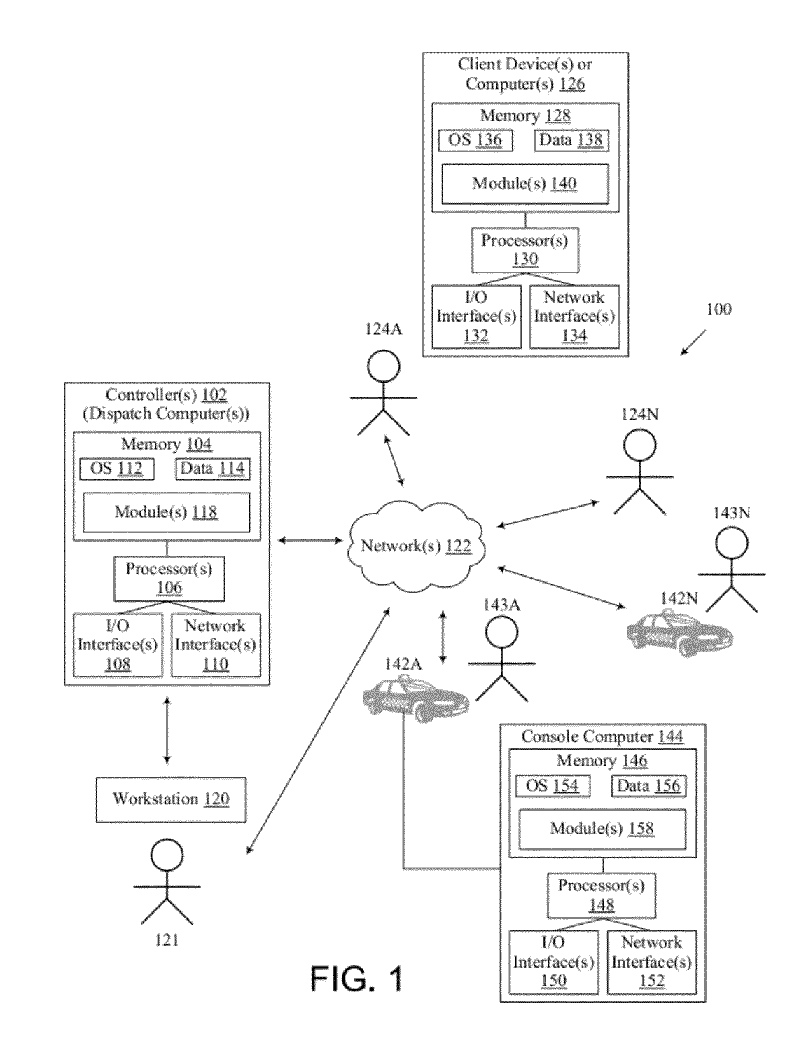

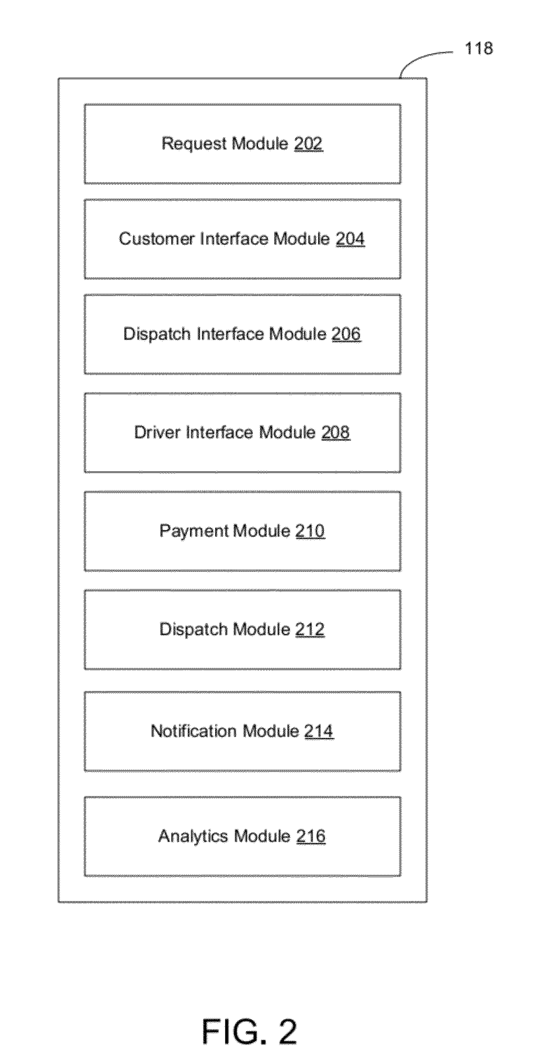

FIG. 1 depicts an automatic fleet management system 100, according to an example embodiment of the invention. In an example embodiment, the system 100 may include one or more controller(s) 102 or dispatch computer(s). The one or more controller(s) 102 may include a memory 104, one or more processors 106, one or more input/output interfaces 108, and one or more network interfaces 110. The memory 104 may include an operating system 112 and data 114. The memory 104 may also include one or more module(s) 118, which may include computer readable code or computer-executable instructions for carrying out one or more of the functions described herein. Example modules are shown and described in FIG. 2, and can include a request module 202, customer interface module 204, dispatch interface module 206, driver interface module 208, payment module 210, dispatch module 212, advanced scheduling module 214, notification module 216, and analytics module 218. Other embodiments may include fewer or greater numbers of modules incorporating some or all of the functionality associated with the modules described below.

In an example embodiment, a local workstation 120 may communicate with the one or more controller(s) 102 for inputting data, displaying information, receiving alerts, etc. A user, such as a dispatcher 121, can interact with the local workstation 120 as needed to receive data and/or commands from the local workstation 120, and to input data and/or commands to the local workstation 120. In the embodiment shown in FIG. 1, one or more network(s) 122 may be in communication with the one or more controller(s) 102, and the one or more network(s) 122 may include wireless, wired, cellular, WiFi™, and/or other communications channels. In an example embodiment, one or more customers 124A-124N may communicate with the one or more network(s) 122 via a respective client device or computer 126. Each client device or computer 126 may include a memory 128, one or more processors 130, one or more input/output interfaces 132, and one or more network interfaces 134. The memory 128 may include an operating system 136 and data 138. The memory 128 may also include one or more module(s) 140, which may include computer readable code or computer-executable instructions for carrying out one or more of the functions described herein. Example modules are shown and described in FIG. 2, and can include a request module 202, customer interface module 204, dispatch interface module 206, driver interface module 208, payment module 210, dispatch module 212, advanced scheduling module 214, notification module 216, and analytics module 218.

According to an example embodiment, the one or more network(s) 122 may be operable to communicate with one or more transportation vehicle(s) 142A-142N with respective drivers 143A-143N, via a respective console computer 144. The vehicles 142A-142N may be similar modes of transportation or may be different modes of transportation. Example modes of transportation and vehicles can include, but are not limited to, public taxis, yellow cabs, private cars, buses, light rail, subway, train, service vehicles, or other forms of transit. Note that the terms “resource,” “driver”, and “service provider” may be used interchangeably throughout this specification. In some embodiments, the term “resource” may be used interchangeably with “vehicle” and/or “service provider.” In any instance, each console computer 144 may include a memory 146, one or more processors 148, one or more input/output interfaces 150, and one or more network interfaces 152. The memory 146 may include an operating system 154 and data 156. The memory 146 may also include one or more module(s) 158, which may include computer readable code or computer-executable instructions for carrying out one or more of the functions described herein. Example modules are shown and described in FIG. 2, and can include a request module 202, customer interface module 204, dispatch interface module 206, driver interface module 208, payment module 210, dispatch module 212, advanced scheduling module 214, notification module 216, and analytics module 218.

In an example embodiment, the one or more controller(s) 102 can be operable to send and receive information between the customers 124A-124N operating a respective client device or computer 126 and the transportation vehicles 142A-142N operating or otherwise equipped with a respective console computer 144.

In example embodiments, the one or more I/O interfaces 108, 132, 150 may facilitate communication between the remote and/or central systems and one or more input/output devices. For example, a universal serial bus port, a serial port, a disk drive, a CD-ROM drive, and/or one or more user interface devices, such as a display, keyboard, keypad, mouse, control panel, touch screen display, microphone, etc., may facilitate user interaction with the remote and/or central systems. The one or more I/O interfaces 108, 132, 150 may be utilized to receive or collect data and/or user instructions from a wide variety of input devices. Received data may be processed by one or more computer processors as desired in various embodiments of the invention and/or stored in one or more memory devices.

One or more network interfaces 110, 134, 152 may facilitate connection of the remote and/or central systems inputs and outputs to one or more suitable networks and/or connections; for example, the connections that facilitate communication with any number of sensors associated with the system. The one or more network interfaces 110, 134, 152 may further facilitate connection to one or more suitable networks; for example, a local area network, a wide area network, the Internet, a cellular network, a radio frequency network, a Bluetooth™ (Owned by Telefonaktiebolaget L M Ericsson) enabled network, a Wi-Fi™ (owned by Wi-Fi Alliance) enabled network, a satellite-based network any wired network, any wireless network, etc., for communication with external devices and/or systems.

According to certain example embodiments service requests may be provided by one or more customers 124A-124N over a client device or computer, such as 126, operating one or more Internet, web, or native applications; messaging application programs; mobile application programs; or other communications channels. For example, a customer may provide a service request via text messaging using a mobile phone or client device, such as 126. Note that the terms “request” and “service request” are used interchangeably throughout this specification. According to example embodiments, one or more these requests can be automatically dispatched to the best driver selected from amongst multiple drivers, based on one or more of the following criteria: the locations of the customer and multiple drivers, the estimated or actual route of the drivers, the current schedule of the drivers and/or the customer, the ability of a driver to provide the service the customer has requested, and other custom parameters specified by the customer, driver or manager.

According to example embodiments, a request may be dispatched to a selected or otherwise designated driver using an in-vehicle driver console, such as a console computer 144, which may display the request on an associated output screen and may optionally narrate, for example, through text-to-voice conversion. According to an example embodiment, the in-vehicle driver console or console computer 144 may collect real-time data from an on-board vehicle diagnostics system or sensor. For example, the console computer 144 may record the real-time or near-real time data about the driving behavior of the driver in the vehicle. According to certain example embodiments, all types of data may be transmitted in real-time or near real-time to a remote server.

According to an example embodiment, software on the remote server may perform real-time data analytics to calculate import metrics, generate charts, and issue alerts. Alerts, for example may include predictive alerts about the impending vehicle maintenance issues. Additional metrics and charts may include, but are not limited to, driver performance and safety analytics, dispatcher performance analytics, and vehicle performance and health analytics.

According to example embodiments, certain technical effects can be provided, such as creating certain systems, methods, and apparatus that provide automated dispatch.

Various modules for achieving fleet management, according to certain example embodiments of the invention, are described below.

Request Module

In one example embodiment, a request module 202 can facilitate obtaining a request from a customer, such as 124A in FIG. 1. The request module 202 may be hosted by the controller 102 or a server, or may be hosted by a mobile device or client device 126 in communication with the controller 102 or a server. In some embodiments, the request module 202 can communicate with the customer interface module 204, dispatch interface module 206, driver interface module 208, payment module 210, dispatch module 212, notification module 214 and/or analytics module 216 to exchange and store information associated with one or more requests. For example, a request module 202 can provide automated phone-based interactive voice request system (IVRS) functionality. A user or customer, such as 124A in FIG. 1, may dial or text a specific phone number which may provide a connection to the IVRS functionality. The request module 202 can provide the user or customer 124A with a dynamic menu that lets the user select from one of his/her previous requests, make a new request and/or listen to or otherwise review any current but not completed requests. In some embodiments, if the user or customer 124A chooses to make a new request, he or she can input request details using the alpha-numeric keypad of the phone, or customer-provided input may be converted by the request module 202 to text and number based requests. In some embodiments, information associated with one or more requests stored on an associated data storage device, database, or memory, such as 104 in FIG. 1, may be searched by the request module 202 using a novel clustering and frequency based sorting algorithm. An example clustering and frequency based sorting algorithm can be as follows:

Step 1. Upon entry of one or more names via touch tone input, a dictionary can map names to their numerical counterparts previously stored by the system. Numerical counterparts of names can be the numbers generated by a touch tone keypad when typing in the name. For example, a is given value 2, b is also given the value of 2, d is given value of 3, etc. Thus, in this example, the word “Klaus” is converted to 5,5,2,8,7 and stored as key-value pair.

Step 2. Every time a location is entered by pressing keys on the touch tone keypad, these keys are searched in the list of names and the ones that match are identified in an order of priority determined in step 3.

Step 3. The list of matches can be prioritized in order as follows:

a) At the top of the list are one or more entries where the entire string of keys entered by a user matches the string of numbers mapped to a name. For example, keys entered as “55287 266788464” match “KLAUS COMPUTING” exactly.

b) Next, one or more entries where a single entered word, as identified by a space separator, can matches a word which is part of a name. For example, keys entered as “55287” can match “KLAUS” from “KLAUS COMPUTING”.

c) Next, one or more entries where only a part of the word is entered, can match a word which is part of the name. For example, keys entered as “5528” can match “KLAU” from “KLAUS COMPUTING”.

d) Next, one or more entries where there is a direct number to number mapping match. For example, keys entered as “5528” can match “5528 Peachtree Rd”.

Step 4. Each of the sublists a), b), c) and d) in Step 3 can be further sorted by the frequency of usage by the customer. So, if “55287” matches both KLAUS and JLAUP, and the customer chose KLAUS more times than JLAUP in previous uses, KLAUS can be prioritized above JLAUP.

Step 5. The customer can be provided with this prioritized list along with an index, i.e., press “1” for KLAUS Computing, press “2” for JLAUP etc.

In some embodiments, the user or customer 124A can select from one or more options in the dynamic menu, and proceed to one or more subsequent menu levels until the request is completed.

By way of another example, the request module 202 can be utilized to implement one or more trip requests in taxis, where a user or customer, such as 124A, interacts with the request module 202 via a phone, client device or computer, such as 126, equipped with touch tones. In this example, a customer 124A may wish to be picked up at the intersection of State Street and 10th Street, in Atlanta, and dropped off at the Atlanta airport. The customer 124A may dial an access number to facilitate contact with the request module. The request module 202 may present the customer 124A with one or more selectable function options, such as make a new request. After selecting a new request, the request module 202 can instruct the customer 124A to input a start location, which initiates a search query. The customer 124A may press the keys 7-8-2-8-3, corresponding to S-T-A-T-E, and the request module 202 may search the database or memory, such as 104, for some or all the streets in Atlanta beginning with or including the term “State.” The request module 202 may provide the customer 124A with a viewable and/or audible list of options to select including an option of “State Street.” The request module 202 may request an intersecting street name, and the search and selection process can be repeated as needed until the start location is sufficiently identified. The request module 202 can request similar information for a destination to initiate a search query, and repeat the search and selection process until the destination location is sufficiently identified. After the start location and destination information has been input to the request module 202, the request module 202 can process a corresponding trip request.

In some embodiments, the request module 202 can be implemented to facilitate handling one or more requests scheduled in advance. The advance time period can range from hours to days and even months.

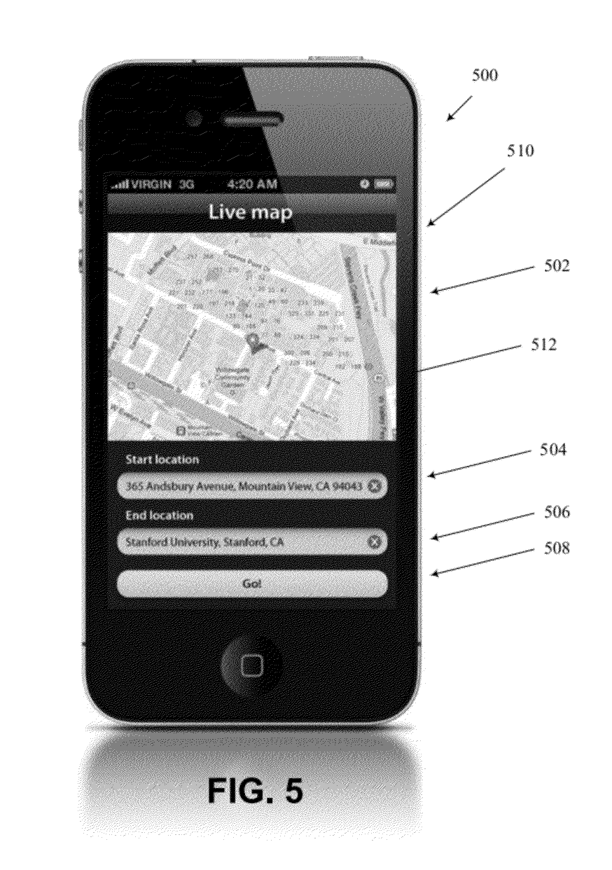

In any instance, example screenshots for a request module 202 to output to a customer are illustrated in FIGS. 5-8 described below.

Customer Interface Module

In one example embodiment, a customer interface module 204 can facilitate obtaining a request from a customer, such as 124A, via an Internet or web-based application program and/or native application program. The customer interface module 204 may be hosted by the controller 102 or a server, or by a mobile device or client device 126 in communication with the controller 102 or server, and can generate one or more webpages or otherwise execute the application program. In some embodiments, the customer interface module 204 can communicate with the request module 202 to exchange and store information associated with one or more requests. For example, a customer 124A operating a personal computer, tablet, or mobile device can interact with the customer interface module 204 via a user interface associated with an application program and/or webpage. The user interface may include the customer's previous requests, may permit the customer 124A to make a new request based on a previous request, or may permit the customer 124 to create a new request by inputting text or speech. In some embodiments, the customer's request may be auto-completed and other results may be provided to the customer 124A as, or when, the customer 124A inputs his or her data. In some embodiments, the results may include the customer's previous requests, and some or all of the previous requests can be sorted based on at least one of the following: frequency of the requests and one or more customer preferences. In an example embodiment, the customer interface module 204 may allow editing of the customer's profile information, for example, editing credit card information, contact address, contact e-mail, contact phone number, etc. In an example embodiment, the application may be a web application, a mobile application on a platform such as Android or iPhone, or another Internet connected device such as an Internet connected GPS device.

In any instance, example screenshots for a customer interface module 204 to output to a customer are illustrated in FIGS. 5-8 described below.

Dispatch Interface Module

According to one example embodiment, a dispatch interface module 206 can facilitate generating a user interface or dispatcher dashboard to be used by one or more users, such as a dispatcher 121 in FIG. 1, to manage some or all the customer requests. The dispatch interface module 206 may be hosted by the controller 102 or a server. In some embodiments, the dispatch interface module 206 can communicate with the request module 202 and/or the customer interface module 204 as needed to exchange and store information associated with one or more requests. For example, a user, such as a dispatcher 121, may utilize a local workstation 120 in FIG. 1, to interact with the dispatch interface module 206. The dispatch interface module 206 can generate a user interface or dispatcher dashboard to output one or more requests submitted via the request module 202 and/or the customer interface module 204. Alternatively, a user, such as a dispatcher 121, can manually add in one or more new requests based on calls and/or messages he or she receives via an associated telephone, mobile device, or messaging device. In some embodiments, the dispatch interface module 206 can output, via the user interface or dispatcher dashboard, each type of request, for example, those made using phone-based IVRS, a web-based application, native applications, and manually input to the local workstation 120 by the user or dispatcher 121. According to example embodiments, the dispatch interface module 206 can also generate, output, and transmit one or more reports and/or charts relating to, for example, dispatch performance, dispatcher performance, driver activity, daily activity, hourly activity for a day, etc. According to some embodiments, the reports and/or charts can be formatted and viewed on any client device, such as via a personal computer or mobile device with an Internet or web browser, or via a downloaded file in a spreadsheet, CSV format, or plain text format. In some embodiments, the dispatch interface module 206 may provide a timely alert to a dispatcher 121 when the process time for a request exceeds a certain predefined limit or if a request needs to be acted upon. According to some embodiments, the alert can be a graphical, tactile, audible, or another type of alert, including an audio or video file.

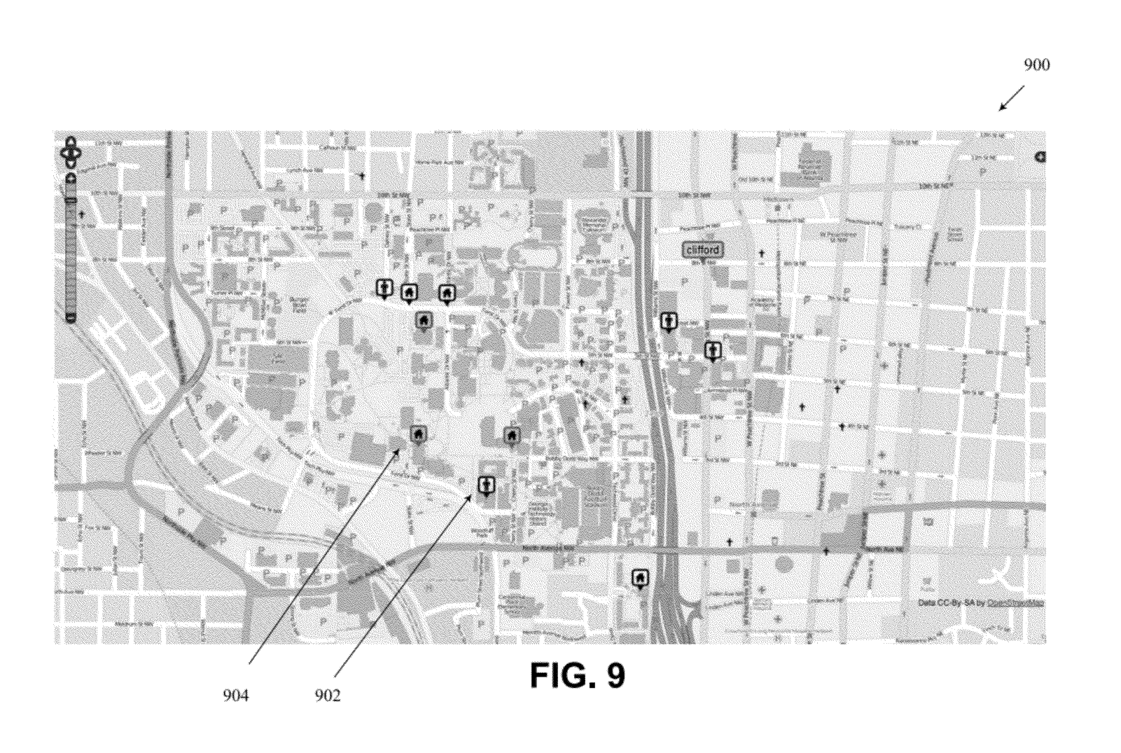

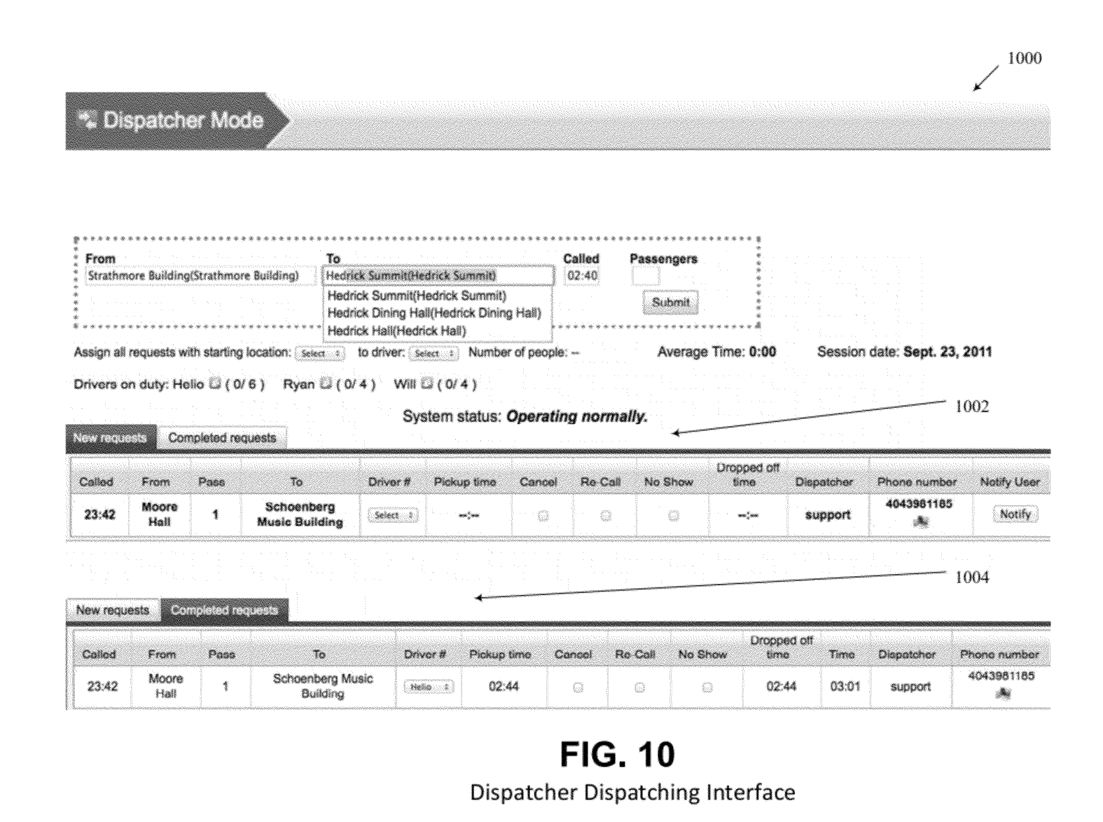

In any instance, example screenshots for a dispatch interface module 206 are illustrated in FIGS. 9-10 described below.

Driver Interface Module

In one example embodiment, a driver interface module 208 can facilitate communications with a console computer, such as 144 in FIG. 1, placed in or otherwise mounted in a vehicle, such as 142A, and used by a driver, such as 143A, or technician. In some embodiments, the driver interface module 208 may be hosted by the controller 102 or a server. In other embodiments, the driver interface module 208 may be hosted by the console computer 144 and communicate with the controller 102 or server. In some embodiments, the driver interface module 208 can communicate with the request module 202, the customer interface module 204 and/or the dispatch interface module 206 as needed to exchange and store information associated with one or more requests. In one example, a console computer 144 can be a processor-based device with a user interface such as an integrated touch screen display, with or without additional input devices such as a keyboard, scanner, or other forms of sensors. The console computer 144 may include text-to-voice and/or voice-to-text capabilities, wherein messages from the driver interface module 208 and received by the console computer 144 can be converted to voice, and commands from the driver 142A to the driver interface module 208 can be input by the driver 142A without a keyboard. The driver interface module 208 can communicate with the dispatch interface module 206 to obtain and display request information at the console computer 144. In some embodiments, the user interface of the console computer 144 may be similar to in appearance and capabilities of the user interface provided by the dispatch interface module 206.

In some embodiments, the console computer 144 may have built-in location-detection or GPS capabilities, and the ability to transmit location coordinates to the controller 102 or a server. In other embodiments, a separate location-detection or GPS device associated with a vehicle, such as 142A, can provide location coordinates to the console computer 144, driver interface module 208, or driver console. According to some embodiments, location coordinates or GPS data transmitted by or via the driver interface module 208 and/or console computer 144 may be used by the dispatch interface module 206.

In one embodiment, the driver interface module 208 may retrieve vehicle data from an on-board diagnostics system using a sensor or direct information feed. Some or all information retrieved, obtained, or input to driver interface module 208 may be periodically transmitted to the controller 102 or a server. In some embodiments, the driver interface module 208 may include one or more sensors and/or algorithms to sense how safely a vehicle, such as 142A, is being driven. For example, the driver interface module 208 can implement a safety analysis algorithm which determines driver and/or vehicle safety based on, for example, speed, change in speed over time (acceleration and/or deceleration), and analysis of displacement, such as speed and acceleration along one or more of 3 axes in a 3 dimensional system. One or more pattern matching algorithms may be applied to the example driver and/or vehicle data to classify changes in the data as safe or unsafe behavior, and rate the driver and/or vehicle using a safety score on a predefined scale. According to some embodiments, a safety score may be displayed by the driver interface module 208 to a driver, such as 143A, via the console computer 144 using visual representations including, but not limited to, a numeric scale, an absolute score, or a color code. According to some embodiments, similar scales may display the status of the vehicle health by using information from on-board diagnostics and/or sensors, and applying pattern matching algorithms to the information. Alternatively, raw data from the diagnostics and/or sensors may be displayed to aid analysis.

Payment Module

According to one example embodiment, a payment module 210 can facilitate collecting payments from one or more customers, such as 124A-124N, when the customer makes a request using any of the above described processes. In some embodiments, the payment module 210 may be hosted by the controller 102 or a server. In other embodiments, the payment module 210 may be hosted by a client device, such as 126 in FIG. 1, and/or the console computer 144 and communicate with the controller 102 or server. In some embodiments, the payment module 210 can communicate with the request module 202, the customer interface module 204, the dispatch interface module 206 and/or the driver interface module 208 as needed to exchange and store information associated with one or more requests. For example, a customer 124A can utilize a mobile device or client device 126 to interact with the payment module 210. The payment module 210 can facilitate a user interface on the mobile device or client device 126 to permit the customer 124A to provide and store payment information, such as credit card or bank details, in a data storage device, database, or memory associated with the payment module 210. In this manner, customers 124A-124N can conveniently access their own payment information without having to input the information each time a request is made. In some embodiments, a console computer 144 may have a detachable or otherwise associated payment information input device to accept a payment from the customer by input via touch screen, connected credit card processing unit, or proximity-based payment system. In some embodiments, the console computer 144 may have a detachable or otherwise associated input device to accept feedback or other input from a customer 124A.

In some embodiments, conventional payment devices and methods can be utilized by the payment module 210.

Dispatch Module

In one example embodiment, a dispatch module 212 can facilitate managing and addressing one or more customer requests. In some embodiments, the dispatch module 212 may be hosted by the controller 102 or a server. In some embodiments, the dispatch module 212 can communicate with the request module 202, the customer interface module 204, the dispatch interface module 206, the driver interface module 208 and/or the payment module 210 as needed to exchange and store information associated with one or more requests. For example, the dispatch module 212 can manage some or all of the requests submitted via the request module 202, and can periodically consider each outstanding request that has not been completed. The dispatch module 212 may determine some or all of tracked vehicles' current location data including, but not limited to, positions, velocities, headings, altitudes, etc. The location data can be obtained from location information or GPS information, such as information received from location-detection or GPS device associated with a vehicle, such as 142A, and transmitted by each driver interface module 208. According to some embodiments, a request start location may be obtained by converting such a position to global coordinates.

In the embodiment shown in FIG. 2, to determine a vehicle to respond to a request, the dispatch module 212 may take into account any number of factors including, but not limited to, the locations of a customer, such as 124A, and multiple vehicles 142A-142N; the estimated, predicted, or actual route of the vehicles 142A-142N; the current schedules of the vehicles 142A-142N and the customer 124A; the ability of each respective driver 143A-143N to provide the service the customer 124A has requested; any number of other custom parameters specified by the customer 124A, driver 143A-143N, or driver's manager or other personnel; and each vehicle's characteristics, current position, velocity, heading, altitude. The dispatch module 212 can utilize some or all of the factors to determine a “best match” vehicle to respond to the request while minimizing one or more of the global costs including, but not limited to, the wait time for the customer 124A, the local cost for a particular vehicle or group of vehicles, conflicts with existing requests, conflicts with existing schedules, and time windows of availability for the customer and/or the driver. In any instance, once a “best match” vehicle is identified by the dispatch module 212, the vehicle may be assigned to a particular request.

For example, the dispatch module 212 can receive one or more service requests from one or more customers, such as 124A-124N. The dispatch module can communicate with the request module 202 and customer interface module 204 as needed to obtain or otherwise receive data associated with the requests. The dispatch module 212 can assign at least one resource, such as one or more vehicles 142A-142N, to each of the customers 124A-124N based at least in part on minimizing travel distance for each resource to a respective customer and minimizing cumulative wait time for the customers. In one instance, a first vehicle A may be 1 mile away from customer P, and a second vehicle B may be 2 miles away from customer P but 10 miles away from person Q. The dispatch module 212 may assign vehicle B to customer P and vehicle A to customer Q even though customer A's wait time increases. In this manner, the cumulative wait time for customers P, Q is (2+2)/2 versus being (1+10)/2. Thus, the cumulative wait time for customers P, Q can be minimized and the travel distance for each assigned vehicle A, B to respective customers P, Q may also be minimized. In other instances, the dispatch module can optimize the resource assignments for more than 2 customers and 2 vehicles or resources.

In some embodiments, a predicted route approach can be used by the dispatch module 212 to determine a vehicle to respond to a request.

By way of another example, a customer's current location can be used by the dispatch module 212 to determine a vehicle to respond to a request. In certain instances, the customer 124A may utilize a mobile device or client device, such as 126, with location services enabled to permit transmission of location information associated with the mobile device or client device 126. The dispatch module 212 may utilize the location information associated with the mobile device or client device 126 when determining a vehicle to respond to a request, or otherwise notifying a driver and/or vehicle about the customer's location in proximity to a request start location. For example, if a customer makes a request for a vehicle to meet him at his apartment, but the customer decides to walk 2 blocks away to a coffee shop before the vehicle arrives, the dispatch module 212 can notify the driver and/or vehicle of the customer's location or proximity to the request start location based on the location information associated with the mobile device or client device 126.

In some embodiments, the dispatch module 212 can facilitate a vehicle assignment at various times when a request is received or otherwise pending. For example, the dispatch module 212 can assign a vehicle as a suggestion to a dispatcher, such as 121, or the dispatch module 212 can assign a vehicle without input from the dispatcher 121. In the absence of input from the dispatcher 121, the dispatch module 212 acts as a decision maker and can process a request by itself. In some instances, a vehicle assignment may ultimately be confirmed or otherwise edited by the dispatcher 121. In another example, the dispatch module 212 can assign a vehicle after accounting for some or all the dynamic and real time (or near real time) requests, changes in requests, and the real time (or near real time) statuses of the vehicles, dispatchers, and drivers and/or technicians involved. Requests assigned by the dispatch module 212 to a particular driver/vehicle may automatically be displayed in a user interface associated with the console computer, such as 144, associated with the vehicle.

In some embodiments, the dispatch module 212 can dynamically re-assign a vehicle upon a cancellation and/or delay, by either a customer 124A or a driver 143A. For example, if the dispatch module 212 detects that a particular driver and/or vehicle assigned to pick up a customer is running late, or has transmitted a cancellation input to the dispatch module 212, the dispatch module 212 can automatically re-assign a different vehicle to the customer 124A and inform the vehicle of the request start location and any other request information or information associated with the customer 124A.

In any instance, in some embodiments, after the dispatch module 212 has assigned a vehicle to a request, the dispatch module 212 may transmit information associated with the request to a driver, such as 143A, via the driver interface module 208, and generate a voice notification alerting the driver 143A to the request along with associated parameters, such as a request starting location.

In some embodiments, the dispatch module 212 can facilitate a marketplace where multiple service providers, such as drivers 143A-143N, can independently set or otherwise input respective prices for their services, such as transportation services, and a customer, such as 124A, can select from the prices depending on the customer's price preference. For example, the dispatch module 212 can receive one or more service requests from a respective number of customers 124A-124N. Location data associated with one or more resources, such as drivers 143A-143N, can be received by the dispatch module 212. Further, price data associated with the one or more resources or drivers 143A-143N can be received by the dispatch module 212. The price data may be independently set by each resource or driver 143A-143N based on the resource or driver's price preference. In some embodiments, the dispatch module 212 can suggest to the resources or drivers 143A-143N one or more prices, such as a range of prices, based at least in part on historical prices for a service, current demand for a service, or the time and/or location for the requested service. The dispatch module 212 may communicate with the analytics module 216 as needed to obtain or otherwise receive historical data, demand data, and times and/or locations. In any instance, based on the identification of the one or more resources or drivers 143A-143N and respective price data, the dispatch module 212 can communicate with the request module 202, customer interface module 204 and/or the notification module 214 as needed to provide at least one of the customers, such as 124A with a selectable list of resources or drivers 143A-143N and associated price data. After customer selection of at least one resource, such as 143A, the dispatch module 212 can communicate with the driver interface module 208 as needed to notify the selected resource, such as 143A, of the respective service request from the customer 124A.

In some embodiments, the dispatch module 212 can suggest variable pricing based on actual or expected demand for services during a predefined period, at a predefined time, or during periods of high demand. The dispatch module 212 may communicate with the analytics module 216 as needed to obtain or otherwise receive pricing data and demand data. For example, on a Friday night in Atlanta, the dispatch module 212 may suggest a price for a taxi service between Buckhead and Midtown based on vehicle availability in the area, the current demand for transportation service between Buckhead and Midtown, and past historical prices for transportation service.

For either of the marketplace or variable pricing functions, the dispatch module 212 can provide a customer 124A with the capability to search and/or sort through any number of service options and/or corresponding prices. For example, the dispatch module 212 can provide one or more options to search transportation options based on, for example, price, time and/or pain. In some embodiments, pain can be defined as a combination of price and time. In some embodiments, a customer preference for a predefined price, time and/or or pain can be used by the dispatch module 212 to recommend, select, sort, or otherwise suggest a particular service option.

In another example, the dispatch module 212 can receive a service request from one or more customers. The dispatch module 212 can provide the one or more customers with one or more resources to select from, wherein the one or more resources can be ranked by a pain measure. The pain measure can based at least in part on some or all of the following: distance between a resource and a customer; customer wait time for a resource; expected travel time for a customer with a resource; a predicted route for a resource; cumulative wait time for one or more customers; customer cost for a resource; a preference of a customer; a past or historical behavior of a customer in selecting a resource; or a past or historical behavior of a customer selecting a particular preference. In one embodiment, a pain measure can be a scale of 0 to 10, with 0 being the lowest pain and 10 being the highest pain. Other pain measures can be used including, but not limited to, numerical measures, colors, textual descriptions, or any combination thereof. In any instance, based at least in part on a customer selection of at least one resource with a pain measure, the dispatch module 212 can assign at least one resource to the one or more customers.

In some embodiments, the dispatch module 212 can determine at least one preference associated with one or more customers. Based at least in part on the at least one preference, the dispatch module 212 can prioritize at least one resource in the plurality of resources for selection by the one or more customers. In some embodiments, the at least one preference can be based at least in part on one of the following: past service requests, past assigned resources, customer behavioral data, or customer preference of a price or price range for a resource.

For example, the dispatch module 212 can recommend one or more resources, such as a combination of resources, to the customer 124A to illustrate a range of pain measures, such as a suggested route, a cheapest route, and a quickest route. In this example, Chris is an employee at PwC who needs to work from his home in Dunwoody. In the past, using the fleet management system, Chris spends a maximum of $10 on a one way trip. The dispatch module 212 can provide three separate options for the trip as described below.

Option 1

Home−>Dunwoody MARTA station: Taxi. Cost: $7

Dunwoody MARTA Station−>PwC near Midtown MARTA Station: MARTA Train Cost: $2.50

Total Cost: $9.50

Trip Duration: 30 minutes

Inclusive of 5 minutes waiting for train

Option 2:

Home−>Dunwoody MARTA station: MARTA Bus Cost: $2.50

Dunwoody MARTA Station−>Pwc: MARTA Train Cost: $0 (transfer)

Total Cost: $2.50

Trip Duration: 40 minutes

Inclusive of 5 minutes waiting for train and 5 minutes waiting for bus

Option 3:

Home−>PwC: Taxi Cost: $40

Total Cost: $40

Trip Duration: 20 minutes

Wait time: 0 minutes

Based on Chris' past behavior and/or a relative pain measure, the dispatch module 212 may pick Option 1 or otherwise prioritize it as a suggested route. Depending on the relative pain measures for the other options, the dispatch module 212 may prioritize the other options as cheapest route or quickest route.

In any instance, example screenshots for a dispatch module 212 to output to a customer are illustrated in FIGS. 5-8 described below.

Notification Module

In one example embodiment, a notification module 214 can notify a customer, such as 124A, about the status of a request. In some embodiments, the notification module 214 may be hosted by the controller 102 or a server, or may be hosted by a mobile device or client device, such as 126, in communication with the controller 102 or server. In some embodiments, the notification module 214 can communicate with the request module 202, the customer interface module 204, the dispatch interface module 206, the driver interface module 208, the payment module 210 and/or the dispatch module 212 as needed to exchange and store information associated with one or more requests. For example, at any point in time during the lifetime of a request, the notification module 214 can generate and transmit one or more notification to the customer 124A about the status of his or her request. Such notifications can be transmitted by the notification module 214 via e-mail, phone call, text, messaging, webpage or website indication, social media messaging, such as Twitter™ or Facebook™ messages, or via other media. Some or all of the notifications may inform the customer 124A about certain events including, but not limited to, an assigned driver and/or vehicle, a driver and/or vehicle being dispatched to a start location or customer location, possible and/or actual delays, possible and/or actual cancellations, and other custom events. In some embodiments, notifications provided by the notification module 214 may be accompanied by a link to a webpage or website which would allow a customer to track the location of an assigned driver and/or vehicle in real time. In some embodiments, the notification module 214 may permit one or more notifications to be customized by a customer 124A, dispatcher 121, driver 142A, or other personnel.

In some embodiments, the notification module 214 can determine an expected wait time and transmit the time to the customer 124. The notification module 214 may receive vehicle information from the driver interface module 208 and/or dispatch module 212, and determine an expected wait time or estimated time of arrival based on the velocity of the vehicle, traffic patterns and/or traffic information. The expected wait time or estimated time of arrival can be transmitted by the notification module 214 to the customer 124A via e-mail, phone call, text, messaging, webpage or website indication, social media messaging, or via other media.

In some embodiments, notifications can be customized for a customer 124A to be able to track only an assigned driver and/or vehicle.

Analytics Module

According one example embodiment, an analytics module 216 can analyze requests, data associated with requests and assigning drivers and/or vehicles to requests, customer behavior, driver and/or vehicle behavior, and/or dispatcher behavior. In some embodiments, the analytics module 216 may be hosted by the controller 102 or a server, or may be hosted by a mobile device or client device, such as 126, in communication with the controller 102 or server. In some embodiments, the notification module 214 can communicate with the request module 202, the customer interface module 204, the dispatch interface module 206, the driver interface module 208, the payment module 210 and/or the dispatch module 212 as needed to exchange and store information. For example, the analytics module 216 may be utilized to process data stored by the controller 102 or a server, and generate one or more graphs and/or reports for output or display to a user, such as a dispatcher 121.

In some embodiments, a chart generated by the analytics module 216 may show raw data collected from one or more vehicles as well as processed data derived by applying one or more algorithms to measure efficiency of the vehicle, driver and/or dispatcher, the health of the vehicle, potential or actual vehicle maintenance issues, and the driver behavior and/or an associated safety score. Additionally data may be subjected to a threshold analysis to identify exceptions such as a vehicle component malfunction, individual incidents of unsafe driving, delays and other customer service exceptions. Such exceptions may result in the generation of an automated alert to the driver, dispatcher or manager delivered via email, phone call, text, webpage or website, or other media.

In some embodiments, the analytics module 216 can determine an expected or anticipated demand for vehicles and/or services based on historical and/or current request information. The analytics module 216 may notify one or more drivers and/or vehicles about an expected or anticipated demand, and may indicate to each of the drivers and/or vehicles where to position themselves to satisfy the expected or anticipated demand. In some embodiments, the analytics module 216 may instruct some or all of the drivers and/or vehicles to go to the same or different locations if the expected or anticipated demand may be satisfied by doing so.

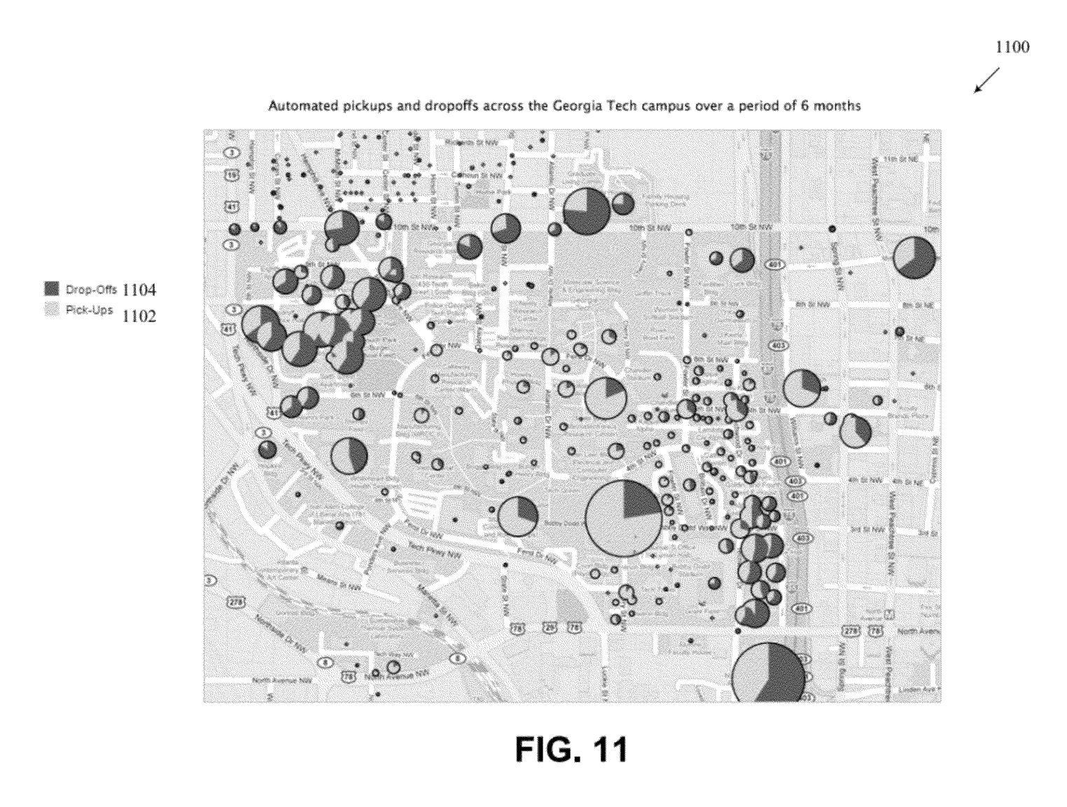

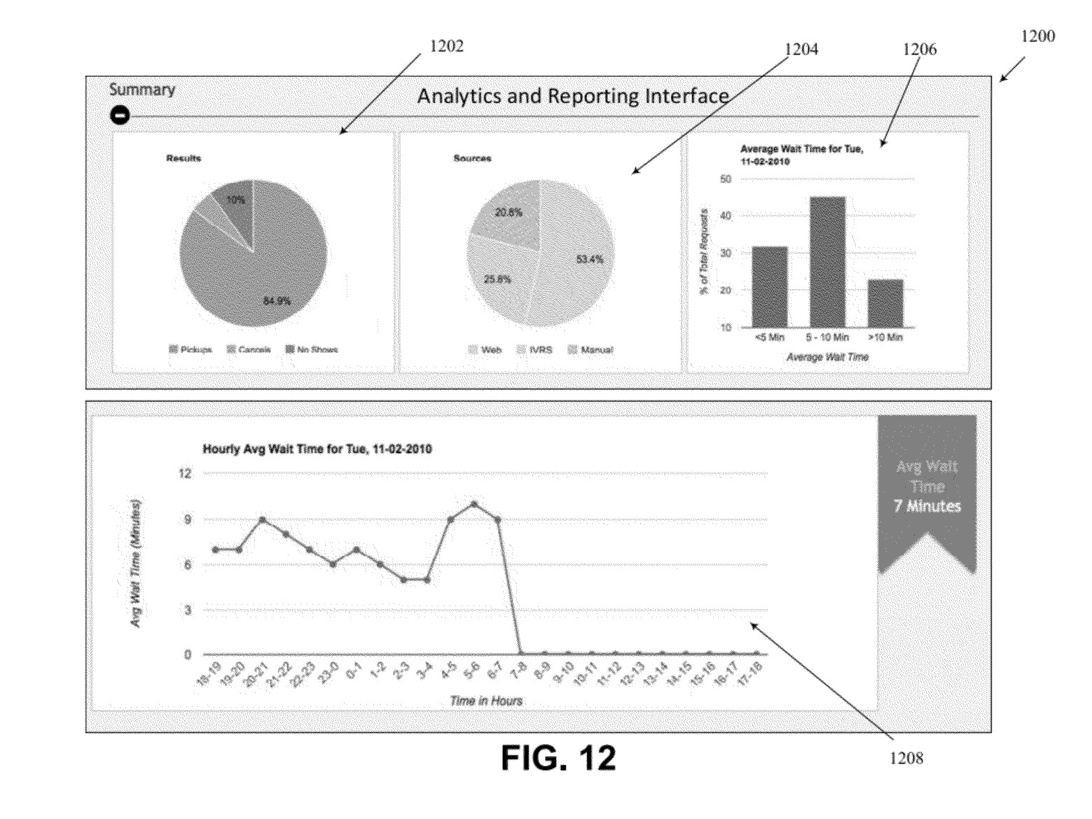

In any instance, example screenshots for an analytics module 216 are illustrated in FIGS. 11 and 12 described below.

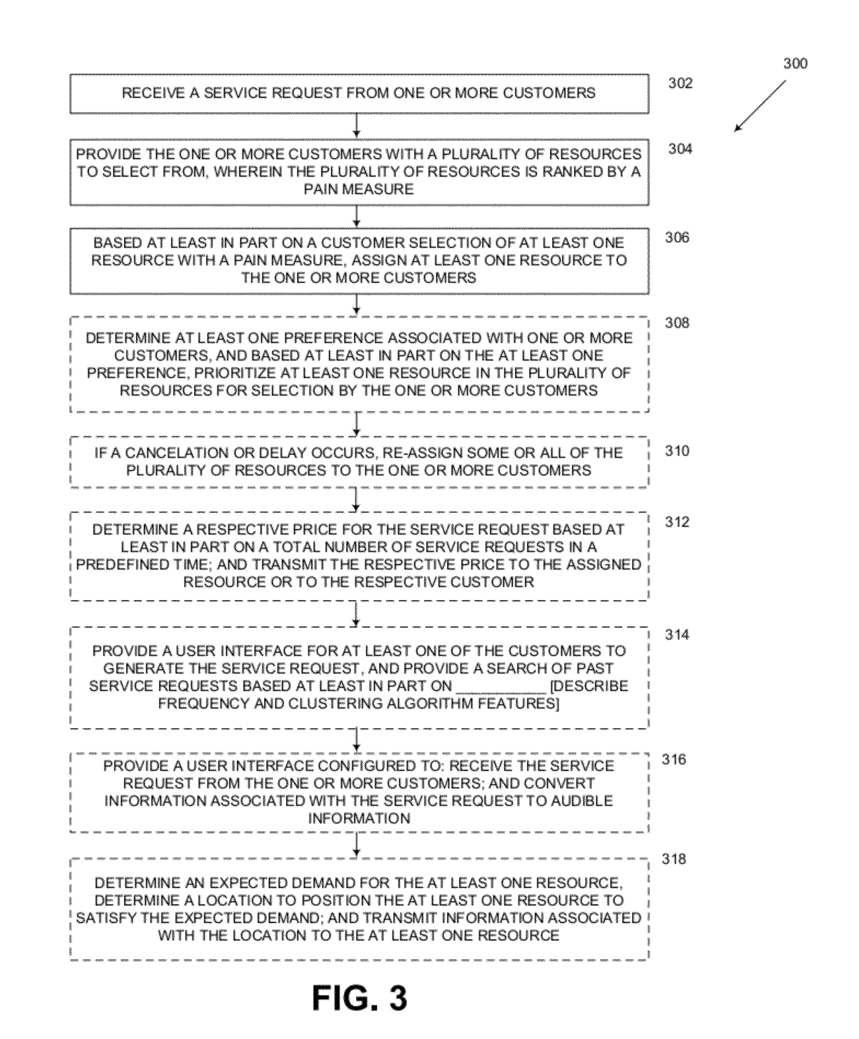

FIG. 3 illustrates a flowchart for a method according to an embodiment of the invention. In certain embodiments, the method 300 can provide fleet management service. The method 300 begin at block 302, in which a service request is received from one or more customers.

Block 302 is followed by block 304, in which the one or more customers are provided with a plurality of resources to select from, wherein the plurality of resources is ranked by a pain measure. In one embodiment, a pain measure can be based at least in part on distance between a resource and a customer; customer wait time for a resource; a predicted route for a resouce; expected travel time for a customer with a resource; cumulative wait time for one or more customers; customer cost for a resource; a preference of a customer; a past or historical behavior of a customer in selecting a resource; or a past or historical behavior of a customer selecting a particular preference.

Block 304 is followed by block 306, in which, based at least in part on a customer selection of at least one resource with a pain measure, at least one resource is assigned to the one or more customers.

Block 306 is followed by optional block 308, in which at least one preference associated with one or more customers is determined, and based at least in part on the at least one preference, at least one resource in the plurality of resources is prioritized for selection by the one or more customers. In one embodiment, at least one preference can be based at least in part on one of the following: past service requests, past assigned resources, customer behavioral data, or customer preference of a price or price range for a resource.

Block 308 is followed by optional block 310, in which, if a cancelation or delay occurs, some or all resources are re-assigned to the plurality of customers.

Block 310 is followed by optional block 312, in which a respective price is determined for some or all of the service requests based at least in part on the number of service requests, and the respective price is transmitted to the assigned resource or to the respective customer.

Block 312 is followed by optional block 314, in which a user interface is provided for at least one of the plurality of customers to generate a service request, and a search of one or more service requests is provided based at least in part on a frequency and clustering algorithm.

Block 314 is followed by optional block 316, in which a user interface is provided configured to: receive a service request from at least one customer, and convert information associated with the service request to audible information.

Block 316 is followed by optional block 318, in which an expected demand is determined for at least one resource, a location to position the at least one resource is determined to satisfy the expected demand, and information associated with the location is transmitted to the at least one resource.

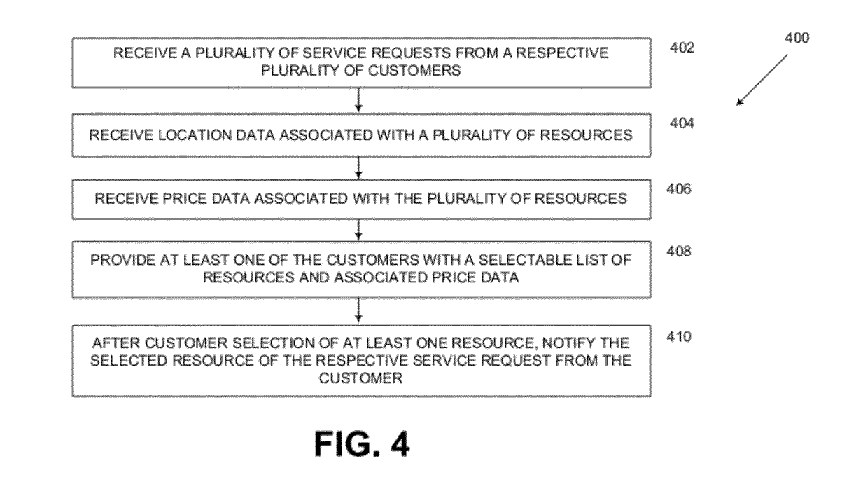

FIG. 4 illustrates a flowchart for another method according to an embodiment of the invention. In certain embodiments, the method 400 can provide a service marketplace. The method 400 begins at block 402, in which a plurality of service requests is received from a respective plurality of customers.

Block 402 is followed by block 404, in which location data associated with a plurality of resources is received.

Block 404 is followed by block 406, in which price data associated with the plurality of resources is received.

Block 406 is followed by block 408, in which at least one of the customers is provided with a selectable list of resources and associated price data.

Block 408 is followed by block 410, in which, after customer selection of at least one resource, the selected resource is notified of the respective service request from the customer.

Certain embodiments of the invention are described above with reference to systems, methods, apparatuses, and/or computer program products according to example embodiments of the invention. It will be understood that one or more of the elements or blocks described above can be implemented by computer-executable program instructions. Likewise, some blocks of the block diagrams and flow diagrams may not necessarily need to be performed in the order presented, or may not necessarily need to be performed at all, according to some embodiments of the invention. Further, the number of elements or blocks described above can be fewer or greater, and may include similar or other functions according to various embodiments.

These computer-executable program instructions may be loaded onto a general-purpose computer, a special-purpose computer, a processor, or other programmable data processing apparatus to produce a particular machine, such that the instructions that execute on the computer, processor, or other programmable data processing apparatus create means for implementing one or more functions specified in the flow diagram block or blocks. These computer program instructions may also be stored in a computer-readable memory that can direct a computer or other programmable data processing apparatus to function in a particular manner, such that the instructions stored in the computer-readable memory produce an article of manufacture including instruction means that implement one or more functions specified in the flow diagram block or blocks. As an example, embodiments of the invention may provide for a computer program product, comprising a computer-usable medium having a computer-readable program code or program instructions embodied therein, said computer-readable program code adapted to be executed to implement one or more functions specified in the flow diagram block or blocks. The computer program instructions may also be loaded onto a computer or other programmable data processing apparatus to cause a series of operational elements or steps to be performed on the computer or other programmable apparatus to produce a computer-implemented process such that the instructions that execute on the computer or other programmable apparatus provide elements or steps for implementing the functions specified in the flow diagram block or blocks.

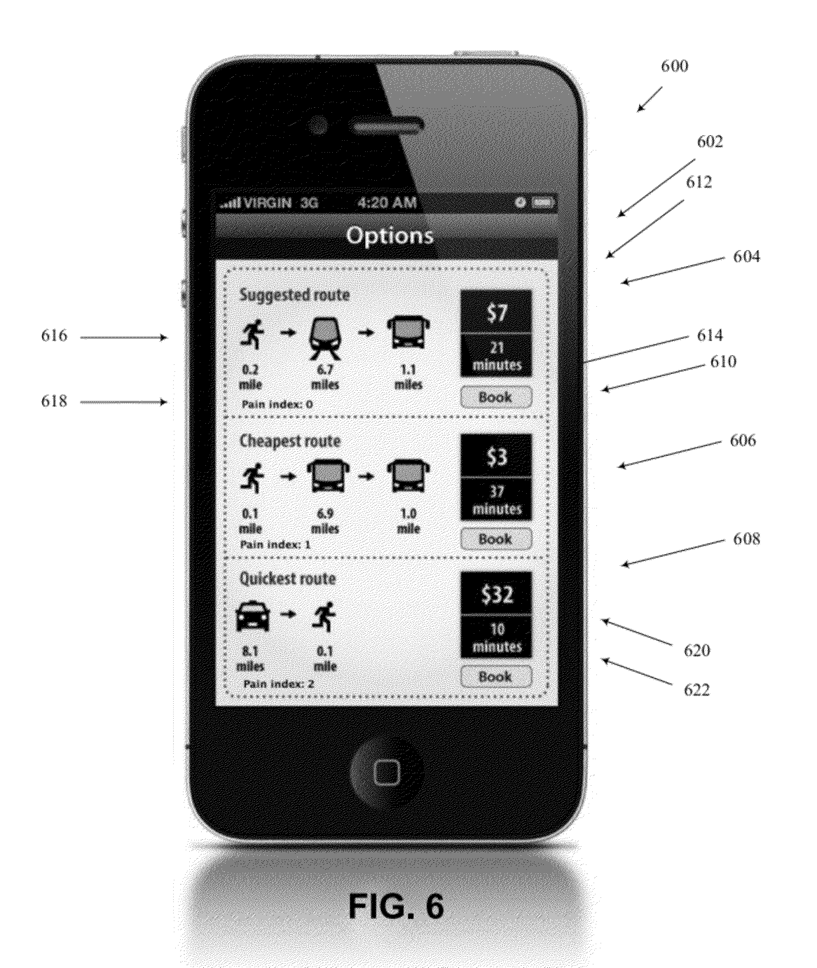

FIGS. 5-6 illustrate example screenshots for an example fleet management system and example method according to an embodiment of the invention. FIG. 5 illustrates an example user interface 500 generated by a request module 202, customer interface module 204 and/or dispatch module 212 to output to a customer, such as 124A in FIG. 1. As shown in FIG. 5, a map box 502, start location window 504, end location window 506, and go command button 508 can be generated on a display screen 510 for a mobile device or client device 512, similar to 126 in FIG. 1. After the customer 124A inputs text into the start location window 504 and end location window 506, and presses the go command button 508, a service request can be initiated by the customer. The map box 502 can illustrate the current location of the customer in proximity to either or both the start location and the end location, or may illustrate a line of travel between the start location and the end location. In any instance, after a service request is initiated, the request module 202, customer interface module 204 and/or dispatch module 212 can generate another user interface 600 as shown in FIG. 6.

As shown in FIG. 6, an options box 602, suggested route window 604, cheapest route window 606, quickest route window 608, and corresponding book command buttons 610 can be generated on a display screen 612 for a mobile device or client device 614, similar to 126 in FIG. 1. After the customer 124A initiates a service request, the user interface 600 can be output to the customer. Each of the suggested route window 604, cheapest route window 606, quickest route window 608 can include information, such as a series of icons 616, detailing transportation between the customer's designated start location and end location. The information can include the type of transportation, such as walking, subway, bus, and taxi, and the distance traveled on each type of transportation. Each of the suggested route window 604, cheapest route window 606, quickest route window 608 can also include a pain measure or pain index 618, a total price 620, and a total time 622. Based on the customer's desired transportation, the customer 124A can input a selection via the corresponding book command buttons 610.

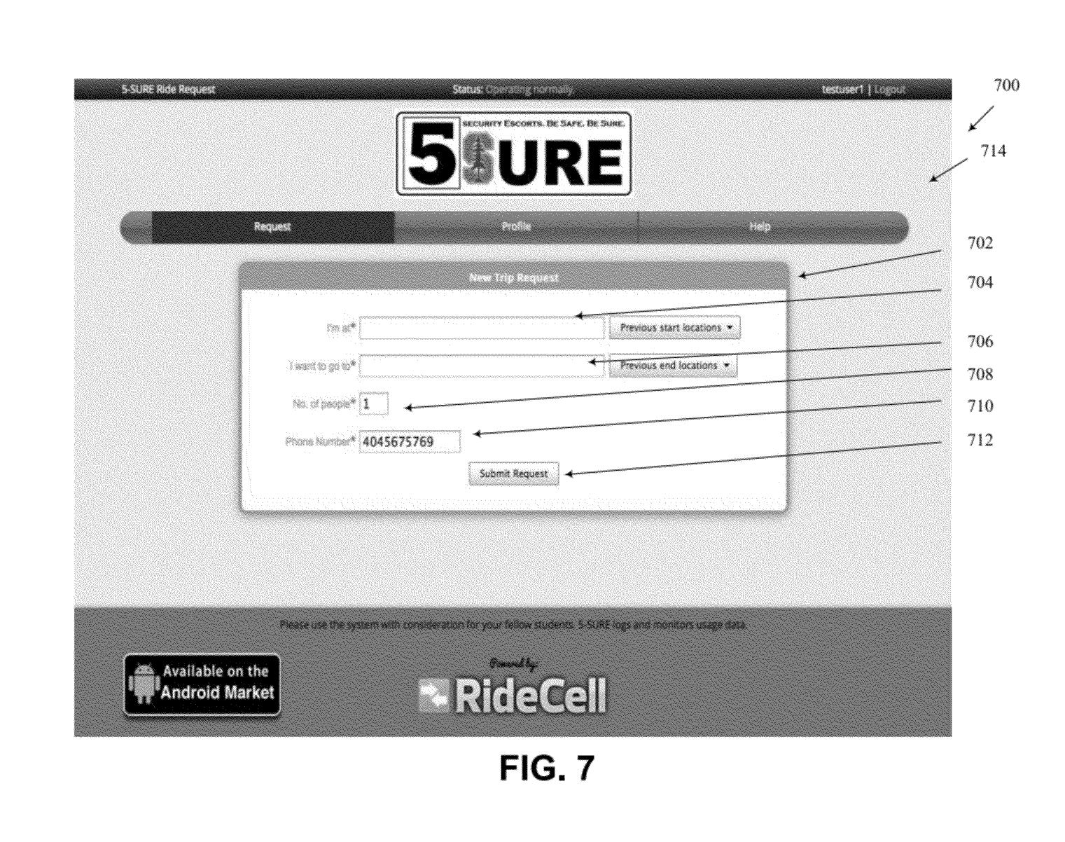

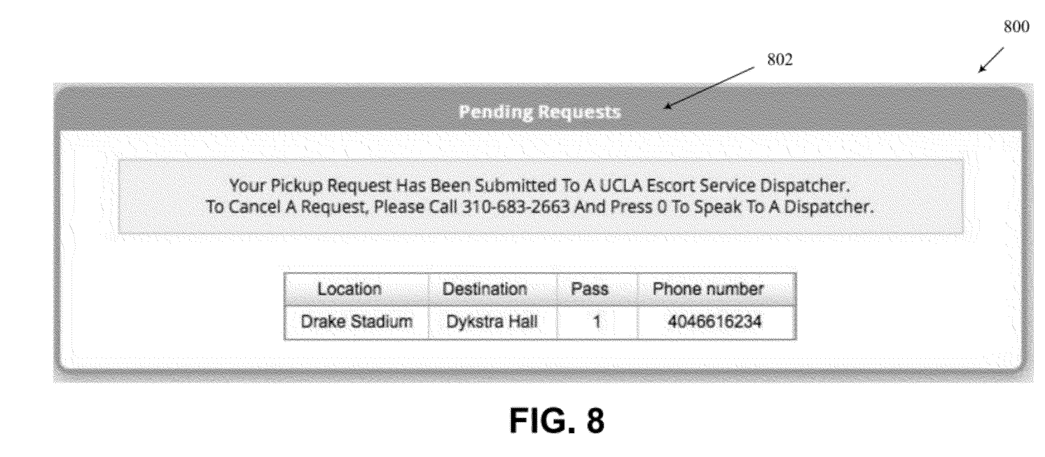

FIG. 7 illustrates another example user interface 700 generated by a request module 202, customer interface module 204 and/or dispatch module 212 to output to a customer, such as 124A in FIG. 1. As shown in FIG. 7, a new trip request box 702, start location window 704, end location window 706, number of people input window 708, and phone number input window 710, and submit request command button 712 can be generated on a display screen 714 for a mobile device or client device, similar to 126 in FIG. 1. After the customer 124A inputs text into the start location window 704, end location window 706, number of people input window 708, and phone number input window 710, and presses the submit request command button 712, a service request can be initiated by the customer. After a service request is initiated, the request module 202, customer interface module 204 and/or dispatch module 212 can generate another user interface 800 as shown in FIG. 8.

FIG. 8 illustrates another example user interface 700 generated by a request module 202, customer interface module 204 and/or dispatch module 212 to output to a customer, such as 124A in FIG. 1. As shown in FIG. 8, a pending request box 802 with information about a pending service request can be generated on a display screen for a mobile device or client device, similar to 126 in FIG. 1.

FIG. 9 illustrates an example user interface 900 generated by a dispatch interface module 206 to output to a dispatcher, such as 121 in FIG. 1. As shown in FIG. 9, a map with a live tracking interface of any number of customers 902, locations 904, and vehicles can be displayed.

FIG. 10 illustrates another example user interface 1000 generated by a dispatch interface module 206 to output to a dispatcher, such as 121 in FIG. 1. As shown in FIG. 10, an interface with any number of new requests 1002 and completed requests 1004 can be displayed with other associated information, such as start location, end location, time of request, passenger number, pickup time, dropoff time, dispatcher name, customer phone number, driver number, etc.

FIG. 11 illustrates an example user interface 1000 generated by an analytics interface module 216 to output to a dispatcher, such as 121 in FIG. 1, or user. As shown in FIG. 11, an interface with any number of pickups 1102 and dropoffs 1102 can be displayed with other associated information, such as the number, relative quantity or volume, location, etc.

FIG. 12 illustrates another example user interface 1200 generated by an analytics interface module 216 to output to a dispatcher, such as 121 in FIG. 1, or user. As shown in FIG. 12, an interface with any number of results 1202, sources 1204, average times 1206, and average wait times 1208 can be displayed.

Other user interface examples can be output by other embodiments of the invention, and the above user interfaces are illustrated by way of example only.

While certain embodiments of the invention have been described in connection with what is presently considered to be the most practical and various embodiments, it is to be understood that the invention is not to be limited to the disclosed embodiments, but on the contrary, is intended to cover various modifications and equivalent arrangements included within the scope of the appended claims. Although specific terms are employed herein, they are used in a generic and descriptive sense only and not for purposes of limitation.

This written description uses examples to disclose certain embodiments of the invention, including the best mode, and also to enable any person skilled in the art to practice certain embodiments of the invention, including making and using any devices or systems and performing any incorporated methods. The patentable scope of certain embodiments of the invention is defined in the claims, and may include other examples that occur to those skilled in the art. Such other examples are intended to be within the scope of the claims if they have structural elements that do not differ from the literal language of the claims, or if they include equivalent structural elements with insubstantial differences from the literal language of the claims.

The claimed invention is:

1. A system for fleet management of one or more resources, comprising:
a processor operable to execute computer-executable instructions stored in at least one memory;
the at least one memory operable to store a dispatch module with computer-executable instructions operable to:
receive a service request from one or more customers;
provide the one or more customers with a plurality of resources to select from, wherein the plurality of resources is ranked by a pain measure; and
based at least in part on a customer selection of at least one resource with a pain measure, assign at least one resource to the one or more customers.

2. The system of claim 1, wherein the pain measure is based at least in part on distance between a resource and a customer; customer wait time for a resource; expected travel time for a customer with a resource; a predicted route for a resource; cumulative wait time for one or more customers; customer cost for a resource; a preference of a customer; a past or historical behavior of a customer in selecting a resource; or a past or historical behavior of a customer selecting a particular preference.

3. The system of claim 1, wherein the dispatch module further comprises computer-executable instructions operable to:
determine at least one preference associated with one or more customers; and
based at least in part on the at least one preference, prioritize at least one resource in the plurality of resources for selection by the one or more customers.

4. The system of claim 3, wherein the at least one preference is based at least in part on one of the following: past service requests, past assigned resources, customer behavioral data, or customer preference of a price or price range for a resource.

5. The system of claim 1, wherein the dispatch module further comprises computer-executable instructions operable to:
if a cancelation or delay occurs, re-assign some or all of the plurality of resources to the one or more customers.

6. The system of claim 1, wherein the at least one memory is further operable to store a request module with computer-executable instructions operable to:
determine a respective price for the service request based at least in part on a total number of service requests in a predefined time; and
transmit the respective price to the assigned resource or to the respective customer.

7. The system of claim 1, wherein the at least one memory is further operable to store a request module with computer-executable instructions operable to:
provide a user interface for at least one of the customers to generate the service request; and
provide a search of past service requests based at least in part on a frequency and clustering algorithm.

8. The system of claim 1, wherein the at least one memory is further operable to store a driver interface module with computer-executable instructions operable to:
provide a user interface configured to:
receive the service request from the one or more customers; and
convert information associated with the service request to audible information.

9. The system of claim 1, wherein the at least one memory is further operable to store an analytics module with computer-executable instructions operable to:
determine an expected demand for the at least one resource;
determine a location to position the at least one resource to satisfy the expected demand; and
transmit information associated with the location to the at least one resource.

10. A method comprising:
receiving a service request from one or more customers;
providing the one or more customers with a plurality of resources to select from, wherein the plurality of resources is ranked by a pain measure; and
based at least in part on a customer selection of at least one resource with a pain measure, assigning at least one resource to the one or more customers.

11. The method of claim 10, wherein the pain measure is based at least in part on distance between a resource and a customer; customer wait time for a resource; expected travel time for a customer with a resource; a predicted route for a resource; cumulative wait time for one or more customers; customer cost for a resource; a preference of a customer; a past or historical behavior of a customer in selecting a resource; or a past or historical behavior of a customer selecting a particular preference.

12. The method of claim 10, further comprising:
determining at least one preference associated with one or more customers; and
based at least in part on the at least one preference, prioritizing at least one resource in the plurality of resources for selection by the one or more customers.

13. The method of claim 12, wherein the at least one preference is based at least in part on one of the following: past service requests, past assigned resources, customer behavioral data, or customer preference of a price or price range for a resource.

14. The method of claim 10, further comprising:
if a cancelation or delay occurs, re-assign some or all of the plurality of resources to the one or more customers.

15. The method of claim 10, further comprising:
determining a respective price for the service request based at least in part on a total number of service requests in a predefined time; and
transmitting the respective price to the assigned resource or to the respective customer.

16. The method of claim 10, further comprising:
providing a user interface for at least one of the customers to generate the service request; and
providing a search of past service requests based at least in part on a frequency and clustering algorithm.

17. The method of claim 10, further comprising:
determining an expected demand for the at least one resource;
determining a location to position the at least one resource to satisfy the expected demand; and
transmitting information associated with the location to the at least one resource.

18. One or more computer-readable media storing computer-executable instructions that, when executed by at least one processor, configure the at least one processor to:
receive a service request from one or more customers;
provide the one or more customers with a plurality of resources to select from, wherein the plurality of resources is ranked by a pain index; and
based at least in part on a customer selection of at least one resource with a pain index measure, assign at least one resource to the one or more customers.

19. The one or more computer-readable media of claim 18, wherein the pain measure is based at least in part on distance between a resource and a customer; customer wait time for a resource; expected travel time for a customer with a resource; a predicted route for a resource; cumulative wait time for one or more customers; customer cost for a resource; a preference of a customer; a past or historical behavior of a customer in selecting a resource; or a past or historical behavior of a customer selecting a particular preference.

20. The one or more computer-readable media of claim 18, further storing computer-executable instructions that, when executed by at least one processor, configure the at least one processor to:
determine at least one preference associated with one or more customers; and
based at least in part on the at least one preference, prioritize at least one resource in the plurality of resources for selection by the one or more customers.
